(19) United States
(12) Patent Application Publication
(10) Pub. No.: US 2025/0033148 A1
(43) Pub. Date: Jan. 30, 2025

(54) Laser processing method with score line inspection

(71) Applicant: Preco, LLC, Somerset, WI (US)

(72) Inventors: Kurt Hatella, New Richmond, WI (US); Corey Jurowski, New Richmond, WI (US); Matt Lackner, Prescott, WI (US)

(21) Appl. No.: 18/909,603

(22) Filed: Oct. 8, 2024

Related U.S. Application Data
(62) Division of application No. 17/037,246, filed on Sep. 29, 2020, now abandoned.
(60) Provisional application No. 62/907,903, filed on Sep. 30, 2019.

(51) Int. Cl. B23K 26/359; B23K 26/06

(52) U.S. Cl. CPC B23K 26/359; B23K 26/0648

(57) ABSTRACT

A laser system and method for inspecting a laser score formed in a moving web of material during laser processing of the material with a laser processing system having a laser source for generating a laser beam and a lens for focusing the laser beam and reflecting the laser beam onto the advancing web of material where the focal point is directed a selected location on the web to produce the score in the advancing web of material, the score having a depth less than the thickness of the material and measuring the depth at one or more locations on the advancing web of material concurrent with producing the score line and where the material may be a packaging material and the score provided for easy opening of the packaging.

### CROSS-REFERENCE TO RELATED APPLICATIONS

This application is a divisional of U.S. application Ser. No. 17/037,246, filed on Sep. 29, 2020 which is based on and claims the benefit of U.S. provisional application Ser. No. 62/907,903, filed on Sep. 30, 2019, the content of which is incorporated herein in its entirety.

### BACKGROUND

The present invention relates to a laser processing system for perforating or scoring a material, and more particularly to the inspection of the score during laser processing.

In food packaging, flexible packaging materials permit colorful packaging graphics, maintain fresh tasting food, allow both freezing and microwave heating, and can be resealed after opening. In non-food packaging, such as lawn and garden products, the packaging permits colorful graphics, maintains long shelf life, allows for resealing to limit odors, and resists punctures and tears.

With the continuous improvements in film properties, flexible packaging can be made thinner than ever before and yet be stronger and tougher than previous packaging. The strength and toughness of the newer films presents a new problem for consumers, namely the packages have become increasingly difficult to open. Furthermore, the strength of the packaging material leads to uneven or uncontrolled tearing during opening.

The technique for laser scoring was first suggested in U.S. Pat. No. 3,626,143. Scribing or laser scoring provides a line of “weakness” in the structure of the film to allow the film to be mechanically broken, such as tearing it by hand. The line of weakness contributes to a controlled-directional open. Generally, low energy, high power density beams are used to remove the material principally as vapor.

While the score line was intended to introduce a line of weakness to make the packaging easier to open, a deep score line is not always desirable. A score line that is cut too deeply will weaken the structure of the film, increasing the likelihood of an accidental burst, such that the packaging cannot withstand shipping and/or storage. Additionally, an overly-deep scored line may destroy the functional characteristics of the multi-layer construction of the film (such as by puncturing a vapor barrier layer). Moreover, the increased exposure to the laser required to produce the deep score line can lead to thermal distortion of the film material, resulting in film buckling when the roll stock is rewound. A score line that is too shallow may produce a tear that does not propagate along a selected path, causing the packaging to improperly open.

Moreover, the start of the tear along the film edge is the most difficult part of the tear because it lacks the assistance of tear propagation or momentum. While the score line provides a line of weakness, if the flexible packaging is folded and scaled to form a pouch, the difficulty in initiating the tear along the score line is compounded by the double thickness of the scored film where the two ends of the film are sealed together. Once a tear is initiated along a score line, the momentum of the initial tear will assist the mechanical tearing operation by propagating the tear along the score line. However, due to the strength and durability of thin film packaging particularly at the sealed edge, not only is initiating the tear difficult, but directing the momentum of the initial tearing operation onto the score line is of principal concern.

Within the flexible packaging industry, there is a need for any easy open or easy tear package that can be readily manufactured without compromising either the durability of the packaging or the functionality of the multi-layered material. Additionally, there is a need for an easy open, easy tear package that can be manufactured inexpensively while still providing a controlled tear with easy tear initiation.

One common way for forming a laser score includes running a web of material under a focused laser and creating a score line as the web passes by the focal point of the laser beam. Alternatively, a focused beam can be moved across the web using a galvanometer scanner. One type of score that requires the focused beam to move is a contoured score having a selected score pattern to control the direction of the opening feature on the packaging. Another type of score requiring motion of the focused beam is a score that is primarily directed across the moving web (rather than in a machine direction). The final score can be either a straight line on the package or it also can be contoured.

### SUMMARY

One aspect of the present disclosure relates to a method of inspecting a laser score line as the score line is being formed in a moving web of material during laser processing. A laser processing system having a laser source for generating a laser beam and a lens for focusing the laser beam is provided for reflecting the laser beam onto the advancing web of material. A focal point of the laser beam is directed to a selected location on the advancing web to produce the score or score line in the material and the score having a depth that is generally less than the thickness of the web of material. The depth of the score is measured at one or more locations on the advancing web of material concurrently with the laser beam continuing to produce scores on the same advancing web.

Another aspect of the present disclosure relates to comparing the measured depth of the score line to a pre-selected depth value or a depth range. When the measured depth matches the pre-selected depth value or otherwise falls within a predetermined depth range, the material continues advancing for continuing to produce the score line. When the measured depth does not match the pre-selected depth value or the depth range, one or more results include the material stops advancing and the laser power is reduced or turned off so as to cease processing of the score line; a controller may generate a signal in response to the measured depth which provides an alarm or warning to a system operator indicating action should be taken to address the score depth and the system may continue operating during this time; the scored material may be marked as a failed material by action of the system; and/or the depth measurement could be fed back to the laser controller to either increase the laser power, to increase a depth of the score, or reduce the laser power to reduce the depth of the score.

Another aspect of the present disclosure relates to directing a laser beam to a surface of a moving web of a thin film for packaging material and for producing a score or perforation in the moving web and concurrently measuring a depth of said score with a sensor. The sensor is positioned downstream of the laser beam and the score is passed through an inspection window associated with the sensor concurrent with laser processing the web to produce the score in the packaging material. The score is inspected for one or more values including depth, which may indicate whether or not the score in the packaging material is sufficient for end uses such as easy opening of the package by a consumer.

The sensor provides a reading to a controller, the reading related to the measured depth of said score and further comparing the reading to one or more preselected depth values for determining a subsequent operational, or “on”/“off”, state for the laser system with respect to laser processing the score.

Yet another aspect of the present disclosure relates to a laser system for forming and inspecting a score line in a moving web of material comprising a laser source for generating a laser beam and a lens for focusing the laser beam and reflecting the laser beam onto the moving web of material to produce a score line in the web; and a sensor spaced apart from the laser beam and positioned such that the score line passes within an inspection window of the sensor. The sensor is configured for measuring a depth of the score line concurrent with producing the score line on the moving web of material.

One or more mirrors may be used to reflect a generated laser beam to a lens where the lens focuses the beam to a fixed location to make a score line as the material is below the beam.

To make a contoured score, again a laser generates a beam and mirrors are used to reflect the beam to a galvo or scanner. The laser beam can be focused before or after the galvo or scanner, and then the galvo or scanner mirrors direct the beam to the material for creating contoured shapes on the material, or the laser beam can be reflected off of the galvo or scanner mirrors and then focused for producing contoured shapes on the material.

The sensor may be placed in-line in a web-direction with the score line such that the score line advances toward and through the inspection window during laser processing.

A controller may also be provided for receiving one or more readings from the sensor related to score depth.

### BRIEF DESCRIPTION OF DRAWINGS

FIG. 1 illustrates a laser system and sensor for inspecting a score.

### DETAILED DESCRIPTION

A system and method for inspecting a score during laser processing is described herein. The system described herein is configured to inspect a score line formed in a web of material, such as packaging material. Inspecting the score line comprises measuring the depth and/or the width of the score line and comparing the depth and/or the width to one or more pre-selected depth and/or width values. The pre-selected depth and/or width values may be optimal depth and/or width values for producing a score in the specific material and/or for the end-use of the material. In further detail, the moving web of material may comprise a material for use in packaging such as a polyester film.

The terms score and score line are used interchangeably throughout this disclosure as a score or score line is generated or produced on the web of material and the score or score line is a weakened area in the material that is a trough such as a v-shaped trough or taper in the thickness of the material. The score line is formed by vaporizing specified areas of the film, creating a narrow channel in the material for a tear to follow.

The laser system comprises a sensor such as a profilometer or similar sensor to inspect the score line. Inspection is carried out via measuring one or more properties of the score line including a depth of the score produced by the laser system. The inspection is carried out in real-time and concurrently with the laser processing of the material. The inspection described herein after in details refers to the depth of the score being inspected, however the width of the score line at one or more points may also be inspected in substantially the same manner as one or more embodiments described herein and may be measured with or without the depth of the same or different sections of the score line. That is, the sensor may be used for measurement of the depth and/or width of a score line during production of the score line for purposes of determining if the score is sufficient for a selected end-use, such as for tear-open packaging.

The laser system is configured and controlled to produce a score line having a selected depth where this depth is less than a thickness of the material. Theoretically the depth of the score can be set and controlled in the laser system, however practically there are multiple factors that may affect the actual depth of the score line since the web material is moving and the dynamics of a moving web will produce a margin of error when forming the score. However, using the disclosure herein, such margin of error can be reduced or eliminated by inspection of the score during processing.

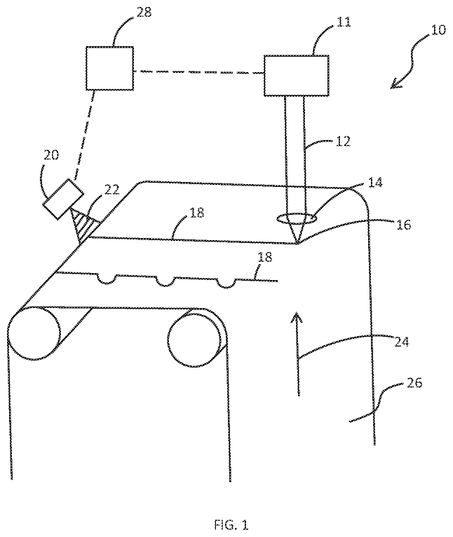

As illustrated in FIG. 1, a laser system 10 generally comprises a laser source 11 for generating a laser beam 12. The laser beam 12 is directed through a focusing lens 14 for directing the laser energy 16 to a web of material 26 for producing a score line 18. In the embodiment illustrated the web of material 26 is a moving web of material which may be a thin film of material, the web direction (direction of movement) indicated by arrow 24. A sensor 22 provides an inspection window 24 on the moving web of material 26. For example, the sensor 22 may be positioned downstream of the laser beam 12 for purposes of inspecting the score line 18 substantially concurrently with the production of the score line 18. The sensor 22 is positioned such that the score line 18 passes through the inspection window 22.

A computer or microprocessor 28 controls the score pattern by controlling mirror angle control motors for directing the laser beam 12 according to a pre-programmed score pattern. The pre-programmed score pattern typically includes both the repeated length of each sheet of the thin film material 26 and the pattern of score line. In the simplest case, the score line is a straight line in the machine direction, where the mirror is fixed and the laser is focused through the focusing lens 14. Additionally, the microprocessor 28 controls a laser power adjust mechanism so as to adjust the power of the laser beam 12.

The microprocessor 28 then controls the laser beam 12 to score the film material 26 to a depth less than a full depth of the material, thus producing the score line 18. The microprocessor 28 may modulate the laser to create tear initiation areas at predetermined locations precisely on the score line 18 or a mechanical method may instead be used so as to create a starting point for initiating a tear to open a package along the score line after the package, constructed of the thin film 26 is sealed. This score line and/or tear initiation point(s) may be inspected according the methods and systems described herein.

The system 10 is used to scribe or score the thin film material 26 which is shown in FIG. 1 as a section of a moving web (moving in the direction of the arrow 24, the machine direction), which typically unwinds from a roller on one side of the laser system 10, passes under the laser beam 12, and is rewound on the other end. The moving web can be held tight using rollers so that the web material does not flap or flutter during operation.

The thin film material 26 may be any printed or coated plastic or cellulose film, paper or Aluminum foil material. Additionally, the system 10 may be used to score any film, paper, foil, metallized material or laminate, such as those produced by adhesive, wax and extrusion lamination. Moreover, the system 10 may be used to score mono and co-extruded plastic (multi-layered) films for special applications. Suitable materials include, but are not limited to, plastic and polymeric materials such as polyethylene (PE), linear and low-density polyethylene (LLDPE and LDPE), polyethyleneterephthalate (PET), oriented polypropylene (OPP), or other polymer. Similar polymers such as, for example, metallocene doped polyethylene are also within the scope of the present invention. Generally, the present invention may be used with either multi-layer homogenous or non-homogenous film materials or single-layer film materials of uniform composition. Generally, any type of flexible packaging material may be laser scored and the score line inspected during processing as taught by the present disclosure. For the purpose of this disclosure, thin film material 26 may be any flexible packaging material of either multiple layers of different compositions or a single layer of uniform composition.

The sensor 20 is configured to inspect the score line 18 for one or more parameters. For example, a depth of the score line may be inspected. The sensor 20 may be configured to indicate that the score line has a sufficient depth based on a measured depth equal to a preselected depth or range of depths and to additionally or alternatively indicate that the score line is insufficient based on a measured depth outside (e.g., above or below) the preselected depth or range of depths. The measurement may then result in a signal indicating that laser processing can continue as-is, or should be stopped for updating laser system parameters for changing the score line quality or depth. In some embodiments, a signal may be sent to the microprocessor 28 for modification of one or more laser processing parameters which directly or indirectly alter the depth of the score line. The sensor 20 may also be used to output a data scan as well as keep track of a moving average of depths of one or more score lines.

The score line 18 is cut to a depth less than the thickness of the flexible sheet 26. The typical thickness of the flexible sheet material is within a range of 1 mil to 20 mils. In one embodiment, the score line 18 should be cut to a minimum depth, which is largely dependent on the thickness of the sheet material and the makeup of its layers. For instance, in the case of a film layer of approximately 1 mil, the score depth probably would approach 0.2 mils. In food packages, the top layer, for example, may consist of polyester or polypropylene to a depth of about 0.5 mils. The next layer may be a barrier layer, which comprises one or more oxygen layers, and then followed by a layer of metallocene, and a layer of polypropylene of polyethylene. The precise order of the layers depends on the type of thin film sheet material, and is unimportant except for determining the depth of the score line 18. During scoring, the sensor 20 is configured to inspect the score line 18 moving through the inspection area 22 and provide a signal indicating that either the score line is within acceptable limits, such as having a depth that is about 0.2 mils or indicating that the score line is either too shallow or too deep and thus one or more laser processing parameters need to be adjusted.

In some cases, it may be important to prevent the laser beam 12 from scoring particular layers. In the case of food packaging, damaging the barrier layer by scoring too deeply may cause the package contents to spoil. The sensor 20 and the computer 28 can be used to control the depth of the score line 18 according to the actual measured depths, the type of material, the material thickness, the particular functionality of the material and so on. Generally, the depth of the score line 18 is the minimum depth required to form a line of weakness without compromising either the functionality of the thin film 26 or the resilience of the packaging.

The methods described herein refer to the depth of the score line, however the methods are carried out in substantially the same manner to measure the width of a score line.

The methods described herein are carried out using a laser assembly and laser processing method for processing a material through the use of laser beam technology. Lasers provide a very efficient method of cutting, scoring, perforating or otherwise preparing selected materials for various end uses over the old mechanical systems, which may include die systems or pin type roller perforators. Lasers cut, score, or perforate the material through the use of a collimated amplified beam of light that terminates in a focal point. It is at or near the focal point of the beam that processing typically occurs. Intense energy at the focal point processes the material in what can be described as essentially a vaporizing, burning or ablating process.

Systems and methods described herein are configured for use when laser processing a score in the web direction, however it is contemplated that laser score line inspection may also be carried out when forming a score across web or otherwise in a contoured manner.

Systems and methods described herein may be used to inspect the depth of a score line in real time and provide immediate feedback for purposes of adjusting laser processing as needed for consistent production of a selected score line during laser processing. The systems and methods described herein may be used to inspect a contoured score line that is in the primary direction of the web as the score passes through an inspection window or area. The systems and methods described herein may also be used to inspect a portion of the score line that is within the inspection devices inspection area. Further, the systems and methods described herein may also be used to inspect multiple score lines such as dual score lines where two score lines are formed concurrently and in close proximity to one another such that both score lines may be inspected with one sensor or additional sensors.

The sensor 20 may be an ultra-high accuracy sensor. A sensor 20 is selected that is capable of inspecting reflective, translucent and/or transparent material. The sensor is installed in the laser processing system at a location above and over a moving web for purposes of inspecting and providing feedback on a depth of the score during production of the score. Lateral positioning of the sensor 20 is selected in part based on the alignment to ensure positioning on substantially a top dead center of a roller to reduce any web flutter.

Inspection for depth may be reported back as “go” or “no go” signal, that is, either the score depth is acceptable or needs adjustment. In some embodiments it may be that the inspection data is fed back to the laser controller and the laser power may then be manually or dynamically adjusted to provide tighter tolerances on the score depth and width.

In some embodiments, multiple score lines are formed along the web direction and spaced apart across the web of material. Often the score lines are farther apart than the inspection window of the sensor allows. A sensor may be mounted after each laser with each providing feedback on the sufficiency of each score. It may further be practical to have the sensor on a programmable axis that will move the sensor to a selected or pre-programmed location, provide feedback on a particular score, and then moving the sensor to the next score line. The position of the sensor may then cycle through every score line and return to a starting point to repeat continued cycling to take a sampling of each score. While such a method would not provide total (e.g., 100%) inspection, such a method would result in statistically significant data sufficient to achieve a confidence level of quality of the score.

### Illustrative Example

A score line is formed substantially in-line with the motion of the web and the laser beam is stationary during laser processing. A sensor is positioned and configured to inspect a depth of the score line directly after the laser has formed the score and thus provide feedback in the form of a depth reading. The depth reading may be an indication of acceptable or unacceptable depth of the score. The sensor is positioned such that the laser score line is produced within a selected inspection area. The sensor has an X-axis inspection zone. In some embodiment, a reduction in the scan frequency improves the accuracy of the depth inspection.

The laser processes the material to produce a score line and the sensor inspects the score line as the web moves in the web direction. Laser processing continues as the score line depth is reported sufficient with respect to the pre-selected depth for the end use application of the material as packaging.

Although the present invention has been described with reference to preferred embodiments, workers skilled in the art will recognize that changes may be made in form and detail without departing from the spirit and scope of the invention.

What is claimed is:

1. A method of inspecting a laser score being formed in a moving web of material during laser processing of the material, the method comprising:
providing a laser processing system having a laser source for generating a laser beam and the laser processing system comprising a lens for focusing the laser beam and reflecting the laser beam onto the advancing web of material;
directing a focal point of the laser beam to a selected location on the web to produce the score in the material along the advancing web of material, the score having a depth; and
measuring the depth of the score at one or more locations on the advancing web of material while producing the score line upstream on the moving web of material.

2. The method of claim 1 and further comprising comparing the measured depth of the score line to a pre-selected depth value or range of depth values.

3. The method of claim 2 wherein when the measured depth matches the pre-selected depth value or range of depth values the material continues advancing for continuing to produce the score line.

4. The method of claim 1 utilizing the measured depth to control the score depth being formed in real time.

5. The method of claim 1 wherein the measured depth is utilized in a statistical analysis to determine the depth of the score produced or being produced.

6. The method of claim 2 wherein when the measured depth does not match the pre-selected depth value or the range of depth values, one or more of the following occurs:
the material stops advancing;
the laser power is reduced to decrease the depth of the score line;
the laser power is increased to increase the depth of the score line;
the laser power is turned off so as to cease processing of the score line; or
the material is marked to indicate an insufficient score line.

7. A method comprising directing a laser beam to a surface of a moving web of packaging material for producing a score or perforation in the packaging material and concurrently measuring a depth of said score with a sensor wherein the sensor is positioned downstream of the laser beam and the score is passed through an inspection window associated with the sensor concurrent with laser processing the packaging material to produce the score therein.

8. The method of claim 7 wherein the sensor provides a reading to a controller, the reading related to the measured depth of said score and further comparing the reading to one or more preselected depth values for determining a subsequent operational state for the laser beam.

9. The method of claim 8 and further comprising ceasing the production of the score or perforation when the measured depth does not match one of the one or more preselected depth values.

10. The method of claim 8 and further comprising continuing the production of the score or perforation when the measured depth matches one of the one or more preselected depth values.

11. The method of claim 10 wherein depth of the score is measured concurrently with forming the score on the same advancing web of material.
